(19) United States
(12) Patent Application Publication
(10) Pub. No.: US 2009/0145353 A1
(43) Pub. Date: Jun. 11, 2009

(54) Moistener for a Mailing Machine

(76) Inventors: Anthony Lawrence, Middlesex (GB); Anthony John Davies, Essex (GB)

Correspondence Address: Don W Bulson;Renner Otto Boiselle & Sklar, 1621 Euclid Avenue, 19th Floor, Cleveland, OH, 44115, US

(21) Appl. No.: 10/503,180

(22) PCT Filed: Jan. 31, 2003
(86) PCT No.: PCT/GB03/00391

§ 371 Date: Mar. 17, 2008

(30) Foreign Application Priority Data
Jan. 31, 2002 (GB) 0202243.2

(51) Int. Cl. B05C 11/02

(52) U.S. Cl. 118/268

(57) ABSTRACT

A moistener for a mailing machine, comprising: a first tank for containing a first body of water, an absorbent element for drawing water from the first tank and presenting a moist surface; a second tank for containing a second body of water; and a valve assembly for metering water from the second tank to the first tank, wherein the valve assembly comprises a valve in fluid communication with the second tank such as, on actuation of the valve, to cause water to be delivered from the second tank to the first tank, and a float unit for actuating the valve in response to a water level in the first tank.

The present invention relates to a moistener for use in mailing machines, particularly in moistening the gummed flaps of envelopes.

Moisteners are currently used in mailing machines, but, problematically, these moisteners tend to deliver a highly variable amount of water to the flaps of envelopes in dependence on the fill level of the water supply tank. When the water supply tanks are full, the moisteners deliver too much water, leading to flooding. And, when the water supply tanks are becoming empty, the flaps are insufficiently moistened, leading to the flaps being poorly secured.

It is an aim of the present invention to provide a moistener which provides for the consistent moistening of mailpieces independent of the level of water in the water supply tank, and which also provides for mailpieces, which do not require any moistening, to be selectively passed therethrough without being moistened.

In one aspect the present invention provides a moistener for a mailing machine, comprising: a first tank for containing a first body of moistening liquid; an absorbent element for drawing moistening liquid from the first tank and presenting a moist surface; a second tank for containing a second body of moistening liquid; and a valve assembly for metering moistening liquid from the second tank to the first tank, wherein the valve assembly comprises a valve in fluid communication with the second tank such as, on actuation of the valve, to cause moistening liquid to be delivered from the second tank to the first tank, and a float unit for actuating the valve in response to a moistening liquid level in the first tank.

Preferably, the first tank comprises a lower tank and the second tank comprises an upper tank, whereby, on actuation of the valve, moistening liquid is gravitationally delivered from the second tank to the first tank.

Preferably, the second tank is a re-fillable tank.

Preferably, the second tank is a replaceable tank.

Preferably, the valve includes a valve member having an actuator pin which provides for actuation of the valve on depression of the same.

Preferably, the float unit comprises an arm mounted about a pivot and a float attached to the arm, with the arm being coupled to the valve such as to operate the same on pivoting of the arm.

More preferably, the pivot is disposed intermediate the ends of the arm, the float is disposed to one end of the arm and the valve is coupled to the other end of the arm.

Still more preferably, the other end of the arm is coupled to the actuator pin of the valve member.

Preferably, the valve assembly is configured such as to maintain the moistening liquid level in the first tank within a height of about 3 mm.

More preferably, the valve assembly is configured such as to maintain the moistening liquid level in the first tank within a height of about 2 mm.

In another aspect the present invention provides a moistener for a mailing machine, comprising: a tank for containing a body of moistening liquid; a mailpiece-receiving surface over which mailpieces, including envelopes having gummed flaps, are in use transported; an absorbent element for drawing moistening liquid from the tank and presenting a moist surface at the mailpiece-receiving surface; and a guide assembly operable to provide for selective moistening of the flaps of envelopes, the guide assembly comprising an arm unit disposed at the mailpiece-receiving surface adjacent the absorbent element and being movable between a first, inoperative position in which mailpieces pass over the mailpiece-receiving surface without being moistened and a second, operative position in which the flaps of envelopes passed over the mailpiece-receiving surface are moistened, and a control mechanism coupled to the arm unit such as to allow the arm unit to be moved selectively between the operative and inoperative positions.

Preferably, the arm unit is pivotable between the first and second positions and is such as to allow mailpieces to pass thereover when in the first, lowered position and to pass between the flap and main body of an envelope when in the second, raised position.

More preferably, the arm unit comprises an arm and a moistening element hinged to a trailing edge of the arm such that, in the absence of a flap of an envelope, the moistening element contacts the absorbent element when the arm is in either the raised position or lowered position, whereby the moistening element retains a substantially uniform moistening liquid content.

Yet more preferably, the moistening element comprises a brush member which includes bristles therealong.

Preferably, the control mechanism comprises a lever as an extension of the arm, a biasing element for biasing the lever to a first position in which the arm is in the lowered position, a control element for operating the control mechanism, and a cam arrangement coupling the lever and the control element such as, on operation of the control element, to provide for the lever to be moved to a second position in which the arm is in the raised, operative position.

In a preferred embodiment the moistening liquid comprises water.

A preferred embodiment of the present invention will now be described hereinbelow by way of example only with reference to the accompanying drawings, in which:

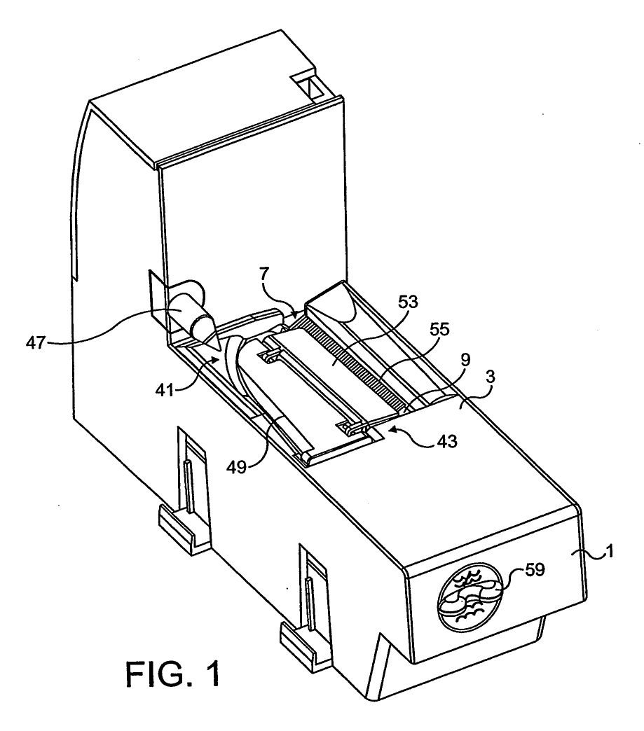

FIG. 1 illustrates a perspective view of a moistener for a mailing machine in accordance with a preferred embodiment of the present invention;

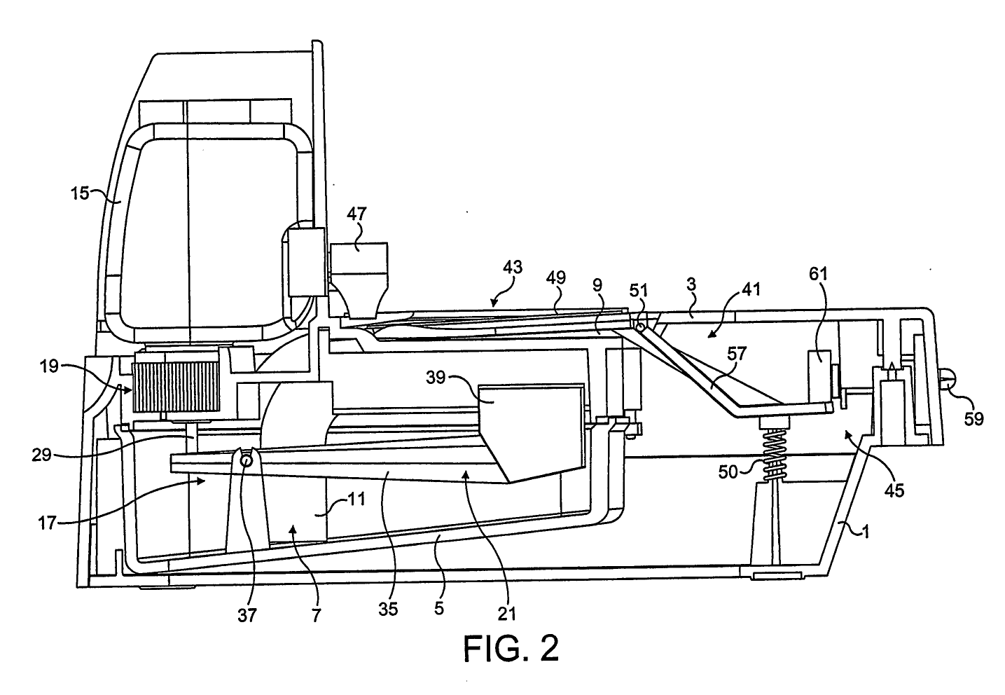

FIG. 2 illustrates a part-sectional view through the moistener of FIG. 1, with the guide assembly in the lowered, inoperative position;

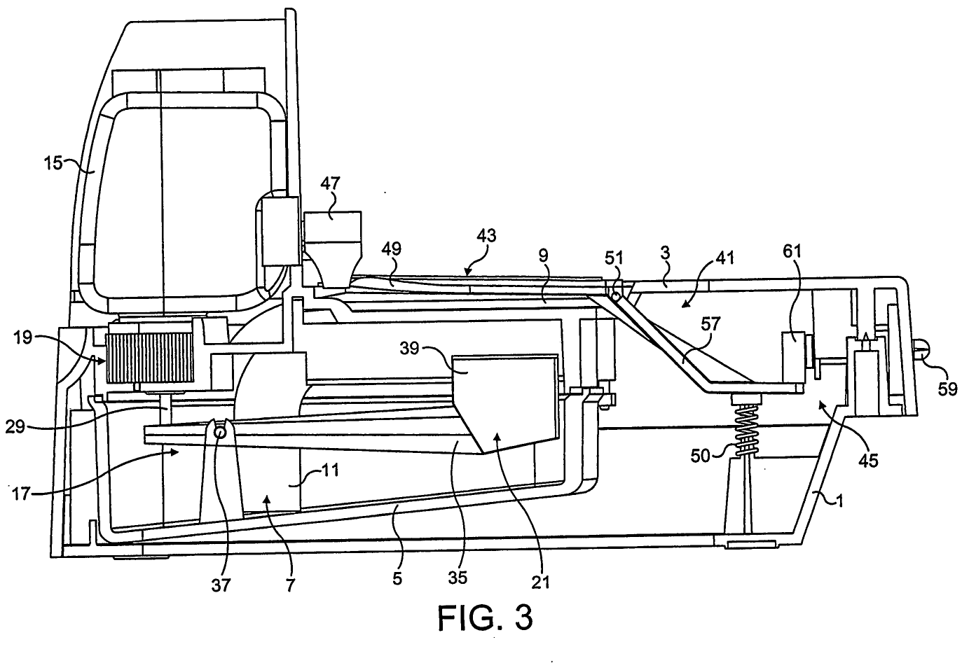

FIG. 3 illustrates a part-sectional view through the moistener of FIG. 1, with the guide assembly in the raised, operative position;

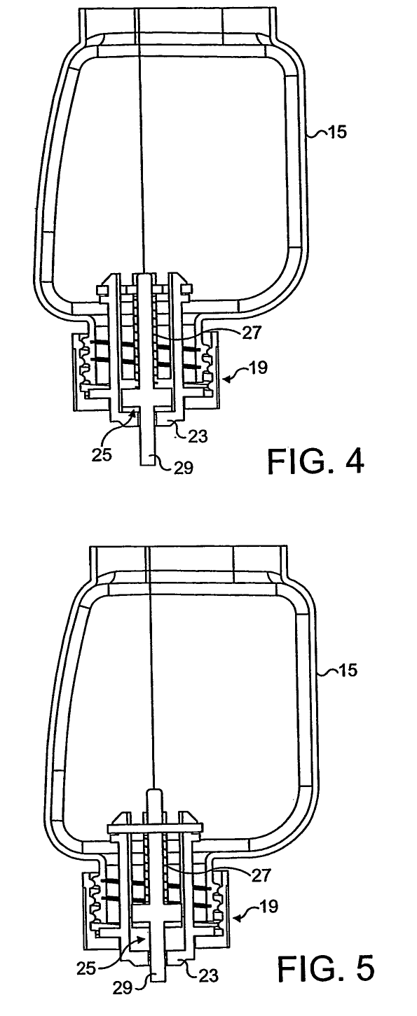

FIG. 4 illustrates a sectional view through the upper tank and the valve of the moistener of FIG. 1, with the valve in the closed configuration; and

FIG. 5 illustrates a sectional view through the upper tank and the valve of the moistener of FIG. 1, with the valve in the open configuration.

The moistener comprises a main housing 1 which defines a mailpiece-receiving surface 3 and includes a first, lower tank 5 for containing a first body of water, an absorbent element 7, in this embodiment a sponge, which comprises a first, main elongate section 9 which is disposed at the mailpiece-receiving surface 3 and presents a moist surface which extends transversely to the direction of transport of mailpieces and a second, trunk section 11 which extends into the first body of water in the lower tank 5 such as to draw water therefrom to the main section 9 thereof.

The moistener further comprises a second, upper tank 15 for containing a second body of water for delivery to the lower tank 5, and a valve assembly 17 for metering water from the upper tank 15 to the lower tank 5 with usage of the water in the lower tank 5.

In this embodiment the upper tank 15 is a refillable tank. In an alternative embodiment the upper tank 15 could comprise a replaceable, pre-filled tank.

The valve assembly 17 comprises a valve 19 which is in fluid communication with the upper tank 15 such that, on actuation of the same, water is delivered, in this embodiment gravitationally, from the upper tank 15 to the lower tank 5, and a float unit 21 for actuating the valve 19 in response to the water level in the lower tank 5.

In this embodiment the valve 19 comprises a valve seat 23, a valve member 25 which is moveable between a closed position (as illustrated in FIG. 4) and an open position (as illustrated in FIG. 5), and a biasing element 27, in this embodiment a compression spring, for biasing the valve member 25 to the closed position. The valve member 25 includes an actuator pin 29 which extends downwardly through the valve seat 23 for providing a means of actuating the valve 19.

In this embodiment the float unit 21 comprises an arm 35 which is mounted about a pivot 37 intermediate the ends thereof, and a float 39 at one end of the arm 35 which is located at the surface of the first body of water in the lower tank 5. The other end of the arm 35 engages the actuator pin 29 of the valve member 25 of the valve 19 such that, on lowering of the water level, and hence the float 39, beyond a predetermined threshold, the arm 35 is pivoted such as to depress the actuator pin 29 and cause the delivery of water from the upper tank 15 to the lower tank 5, and, on restoration of the water level to a predetermined threshold, the arm 35 is pivoted away from the actuator pin 29 such that the valve member 25 is moved to the closed position under the action of the biasing element 27, whereby the valve 19 is closed.

With this configuration, a near constant water level can be maintained in the lower tank 5, typically maintaining a water level which varies by only about 2 to 3 mm, irrespective of the water level in the upper tank 15. In this way, the absorbent element 7 provides for the moistening of the flaps of envelopes to the same degree.

The moistener further comprises a guide assembly 41 for providing for the selective moistening of the flaps of envelopes. The guide assembly 41 comprises an arm unit 43 which is disposed at the mailpiece-receiving surface 3 adjacent the absorbent element 7 and movable between a first, lowered position (as illustrated in FIG. 2) in which mailpieces pass over the mailpiece-receiving surface 3 without being moistened and a second, raised position (as illustrated in FIG. 3) in which the flaps of envelopes passed over the mailpiece-receiving surface 3 are moistened, a control mechanism 45 which is coupled to the arm unit 43 such as to allow the arm unit 43 to be positioned selectively in the operative and inoperative positions, and a guide element 47 which is mounted to the housing 1 above and at a leading edge of the mailpiece-receiving surface 3 for guiding mailpieces over the mailpiece-receiving surface 3.

The arm unit 43 comprises an arm 49 which is pivoted about a pivot 51 to the housing 1 and has a chamfered leading edge, the arm 49 being such as to pass between the flap and main body of an envelope when in the raised, operative position and to allow mailpieces to pass thereover when in the lowered, inoperative position, and a brush member 53 which include bristles 55 along the trailing edge thereof and is hinged to the trailing edge of the arm 49 such that, in the absence of an envelope, the bristles 55 contact the absorbent element 7 when the arm 49 is in either the operative position or inoperative position, whereby the bristles 55 retain a substantially uniform water content. In this way, with the arm unit 43 in the operative position, the gummed flap of an envelope is moved away from the main body thereof such as to allow for the flap to be moistened.

The control mechanism 45 comprises a lever 57 as an extension of the arm 49, a biasing element 50, in this embodiment a compression spring, for biasing the lever 57 to a first, raised position (as illustrated in FIG. 2) in which the arm 49, and hence the arm unit 43, is in the lowered, inoperative position, a control element 59, in this embodiment a rotatable knob, for operating the control mechanism 45, and a cam arrangement 61 which couples the lever 57 and the control element 59 such as, on operation of the control element 59, to provide for the lever 57 to be lowered to a second, lowered position (as illustrated in FIG. 3) in which the arm 49, and hence the arm unit 43, is in the raised, operative position.

Finally, it will be understood that the present invention has been described in its preferred embodiment and can be modified in many different ways without departing from the scope of the invention as defined by the appended claims.

1. A moistener for a mailing machine, comprising:
a first tank for containing a first body of moistening liquid;
an absorbent element for drawing moistening liquid from the first tank and presenting a moist surface;
a second tank for containing a second body of moistening liquid; and
a valve assembly for metering moistening liquid from the second tank to the first tank, wherein the valve assembly comprises a valve in fluid communication with the second tank and being actuatable to cause moistening liquid to be delivered from the second tank to the first tank, the valve comprising a valve member movable between a first, closed position and a second, open position in which the first and second tanks are in fluid communication and a biasing element for biasing the valve member to the closed position, and a float unit for actuating the valve in response to a moistening liquid level in the first tank.

2. The moistener of claim 1, wherein the first tank comprises a lower tank and the second tank comprises an upper tank, whereby, on actuation of the valve, moistening liquid is gravitationally delivered from the second tank to the first tank.

3. The moistener of claim 1, wherein the second tank is a re-fillable tank.

4. The moistener of claim 1, wherein the second tank is a replaceable tank.

5. The moistener of claim 1, wherein the valve member has an actuator pin which provides for actuation of the valve on depression of the same.

6. The moistener of claim 1, wherein the float unit comprises an arm mounted about a pivot and a float attached to the arm, with the arm being coupled to the valve such as to operate the same on pivoting of the arm.

7. The moistener of claim 6, wherein the pivot is disposed intermediate the ends of the arm, the float is disposed to one end of the arm and the valve is coupled to the other end of the arm.

8. The moistener of claim 7 when the valve member has an actuator pin which provides for actuation of the valve on depression of the same, wherein the other end of the arm is coupled to the actuator pin of the valve member.

9. The moistener of claim 1, wherein the valve assembly is configured such as to maintain the moistening liquid level in the first tank within a height of about 3 mm.

10. The moistener of claim 9, wherein the valve assembly is configured such as to maintain the moistening liquid level in the first tank within a height of about 2 mm.

11. A moistener for a mailing machine, comprising:
a tank for containing a body of moistening liquid;
a mailpiece-receiving surface over which mailpieces, including envelopes having gummed flaps, are in use transported;
an absorbent element for drawing moistening liquid from the tank and presenting a moist surface at the mailpiece-receiving surface; and
a guide assembly operable to provide for selective moistening of the flaps of envelopes, the guide assembly comprising an arm unit disposed at the mailpiece-receiving surface adjacent the absorbent element and being movable between a first, lowered inoperative position out of operative engagement with mailpieces in which mailpieces pass over the mailpiece-receiving surface without being moistened and a second, raised operative position in which the flaps of envelopes passed over the mailpiece-receiving surface are moistened, and a control mechanism coupled to the arm unit such as to allow the arm unit to be moved selectively between the operative and inoperative positions.

12. The moistener of claim 11, wherein the arm unit is pivotable between the lowered and raised positions and is such as to allow mailpieces to pass thereover when in the lowered position and to pass between the flap and main body of an envelope when in the raised position.

13. The moistener of claim 12, wherein the arm unit comprises an arm and a moistening element hinged to a trailing edge of the arm such that, in the absence of a flap of an envelope, the moistening element contacts the absorbent element when the arm is in either the raised position or lowered position, whereby the moistening element retains a substantially uniform moistening liquid content.

14. The moistener of claim 13, wherein the moistening element comprises a brush member which includes bristles therealong.

15. The moistener of claim 13, wherein the control mechanism comprises a lever as an extension of the arm, a biasing element for biasing the lever to a first position in which the arm is in the lowered position, a control element for operating the control mechanism, and a cam arrangement coupling the lever and the control element such as, on operation of the control element, to provide for the lever to be moved to a second position in which the arm is in the raised position.
